(19) United States
(12) Patent Application Publication
(10) Pub. No.: US 2026/0029934 A1
(43) Pub. Date: Jan. 29, 2026

(54) METHOD AND DEVICE FOR IMPROVING READ PERFORMANCE OF AN EMBEDDED MULTIMEDIA CARD

(71) Applicant: Silicon Motion Inc., Jhubei (TW)

(72) Inventors: Wen-sheng LIN, Jhubei (TW); Lo chun LIAO, Jhubei (TW)

(21) Appl. No.: 19/049,032

(22) Filed: Feb. 10, 2025

(30) Foreign Application Priority Data
Jul. 23, 2024 (TW) 113127506

(51) Int. Cl. G06F 3/06

(52) U.S. Cl. CPC G06F 3/0625; G06F 3/0659; G06F 3/0679

(57) ABSTRACT

The present disclosure relates to a method and device for enhancing read performance of an eMMC. The method is executed by a processing unit of a flash memory controller and comprises the following steps: (a) receiving an open-ended read command from a host device, wherein the parameters of the open-ended read command include a data address; (b) reading a first batch of data from a flash memory device according to the data address, storing it in a buffer, and during this process, monitoring the amount of data to identify when it reaches a threshold amount, at which point the amount of data is sent to the host device; (c) reading a second batch of data from the flash memory device and storing it in the buffer; and (d) checking if a stop command has been received, and if the check result is YES, terminating the execution of the open-ended read command.

### CROSS REFERENCE TO RELATED APPLICATIONS

This application claims priority to Taiwan Patent Application Serial No. 113127506, filed Jul. 23, 2024, the entire contents of which are incorporated herein by reference.

### FIELD OF DISCLOSURE

This present disclosure relates to storage devices, particularly a method and device for improving read performance of an embedded multimedia card.

### BACKGROUND

A multimedia card (MMC) is a flash memory card standard. An embedded multimedia card (eMMC) is an architecture having an embedded storage solution with an MMC interface, flash memory and controller, all packaged together. Within eMMC specification, many eMMC commands CMD0˜CMD48 are defined, and the host device controls the eMMC device by issuing eMMC commands. The eMMC device consists of a controller and a flash memory device. The controller performs tasks such as data reading, writing, erasing, and stopping on the flash memory device upon received eMMC commands. For more information on details such as command format and the usage of individual bits, please refer to the eMMC specification. Commands related to data reading include: (1) the single-block read command CMD17 and the multiple-block read command CMD18 with the command parameters including a start address of the data reading; (2) the command CMD16, which is sent before the command CMD18 to specify the length of the data read; and (3) the stop command CMD12. According to the eMMC specification, the host device has the option to send a command CMD18 directly to the eMMC device without the need to first send a command CMD16. In such a scenario, the read length is unspecified and the command CMD18 is referred to as an open-ended multiple-block read command. The controller will read data from the flash memory device constantly until it receives a stop command CMD12 from the host device. This is especially well-suited for the case of reading large amounts of required data but is less optimal for reading a small amount of required data. In the following content, all of the commands CMD18 mentioned are open-ended multiple-block read commands, abbreviated open-ended read command CMD18 or open-ended read command for convenience.

FIG. 1 is a timing diagram illustrating the operation process of an open-ended read command CMD18 for reading a small amount of required data in the prior art. At time t₁, the host device sends an open-ended read command CMD18 to the eMMC device. Upon detection of this command by the processing unit within the controller of the eMMC device at time t₂, the first batch of data is read via Direct Memory Access (DMA) from the flash memory device and temporarily stored in a buffer. For example, with a batch-read data amount of 32 KB, at time t₃, the buffer stores the first batch of 32 KB data. The processing unit subsequently executes another DMA to transfer this first batch of 32 KB data from the buffer to the host device. Meanwhile, the processing unit can still carry out other tasks, such as detecting and executing the received eMMC commands. In this case, since no stop command CMD12 has been received, at time t₄, the processing unit continues to read a second batch of 32 KB data, and at time t₆, the buffer has stored the second batch of 32 KB data. The processing unit then executes DMA to send this second batch of 32 KB data from the buffer to the host device. The processing unit proceeds to execute other operations and read a next batch of data at time t₇. The operation repeats and continues in this manner. After receiving the first batch of 32 KB data at time t₅, the host device, considering that the required data amount has been met, proceeds to send a stop command CMD12 to the eMMC device. However, as the transmission and processing take time, it usually cannot be detected by the processing unit at time t₆. Instead, it will be detected at time t₈ when the next batch of data has been read. At this point, the processing unit will respond to the stop command CMD12 to stop subsequent reading operations and will no longer continue reading from the flash memory device.

The open-ended read command CMD18 was initially intended for efficiently reading a large amount of required data; however, it unfortunately does not perform well when reading a small amount of required data. As shown in FIG. 1, when the host device uses CMD18 to read a single batch of data (e.g., 32 KB), it causes the eMMC device's processing unit to spend a duration of time from t₂ to t₈, which is nearly the same amount of time that the processing unit would take to read three batches of 32 KB data. This results in a decrease in the controller's performance. Since some existing electronic devices, such as wearable devices, utilize command CMD18 to read small amount of required data, there is a need for improvement method to enhance data read performance.

### SUMMARY OF DISCLOSURE

In order to reduce or eliminate problems in the above-mentioned areas, the present disclosure reveals a method, executed by a processing unit of a flash memory controller, for improving read performance of an embedded multimedia card. The method comprises the following steps: (a) receiving a first open-ended read command from a host device, wherein the parameters of the first open-ended read command include a first data address; (b) reading a first batch of data from a flash memory device according to the first data address, storing the first batch of data in a buffer, and during this process, monitoring the amount of data stored in the buffer to identify when the amount of data reaches a threshold amount (e.g. 4K), at which point the amount of data is sent to the host device, wherein the threshold amount is less than a batch-read data amount (e.g. 32K); (c) reading a second batch of data from the flash memory device and storing the second batch of data in the buffer; and (d) checking if a stop command has been received from the host devices, and if the check result is YES, terminating the execution of the first open-ended read command.

In some embodiments, when the check result in step (d) is YES, the method further comprises the following steps: (e) checking whether a second open-ended read command has been received, wherein parameters of the second open-ended read command include a second data address; (f) performing a continuity check, and if the check result is YES, proceeding to step (g); and (g) when a second batch of data in the buffer is complete, sending the second batch of data in the buffer to the host device, and reading a third batch of data from the flash memory device and storing the third batch of data in the buffer; wherein the continuity check comprises a check condition: (1) the second data address follows immediately after an end address of the data read by the first open-ended read command. The continuity check may optionally further comprise another condition: (2) a cumulative data read amount of the first open-ended read command is a small amount of required data.

In some embodiments, after step (g), the method further comprises the following steps: (h) checking whether the cumulative data read amount of the second open-ended read command is greater than or equal to the cumulative data read amount of the first open-ended read command, and if the check result is YES, proceeding to step (i); (i) waiting for a preset time; and (j) checking if a stop command has been received from the host device.

In another aspect, this present disclosure reveals an electronic device, comprising: a host device; a flash memory device; and a flash memory controller coupled to the host device and the flash memory device, wherein the flash memory controller comprises: a host interface for coupling to the host device; a flash memory interface for coupling to the flash memory device; a buffer; and a processing unit coupled to the buffer, the host interface, and the flash memory interface, for receiving eMMC commands from the host device through the host interface, and accessing the flash memory device through the flash memory interface, wherein the processing unit is configured to perform the aforementioned method for enhancing read performance.

In another aspect, the present disclosure also reveals a flash memory controller, coupled to a host device and a flash memory device. The flash memory controller comprises: a host interface for coupling to the host device; a flash memory interface for coupling to the flash memory device; a buffer; and a processing unit coupled to the buffer, the host interface, and the flash memory interface, for receiving eMMC commands from the host device through the host interface, and accessing the flash memory device through the flash memory interface, wherein the processing unit is configured to perform the aforementioned method for enhancing read performance.

Compared to prior art technologies, the method and device revealed in the present disclosure allows the host device to receive data and issue a stop command earlier for the case of small amount of required data. This enables the premature termination of open-end reading operations, improving reading efficiency and avoiding unnecessary data transfer as well as delays in stopping transmission, thereby mitigating issues related to energy consumption and latency.

### BRIEF DESCRIPTION OF DRAWINGS

FIG. 1 is a timing diagram illustrating the operation process of an open-ended read command for reading a small amount of required data in the prior art.

FIG. 2 is a block diagram of the electronic device according to an embodiment of the present disclosure.

FIG. 3 is a flowchart of the method for executing open-ended read commands according to an embodiment of the present disclosure.

FIG. 4 is a timing diagram illustrating the operation process of a single open-ended read command for reading a small amount of required data, corresponding to the embodiment shown in FIG. 3.

FIG. 5 is a timing diagram illustrating the operation process of consecutive first and second open-ended read command for reading a small amount of required data, corresponding to the embodiment shown in FIG. 3.

### DETAILED DESCRIPTION

The following descriptions outline preferred embodiments of the present disclosure, aiming to describe the fundamental spirit of this disclosure without limiting it. The actual content of the invention must be referenced in the claims of the application. The terms “first,” “second,” “third,” etc., used in the claims, are intended to modify the components within the claims and do not signify any priority among them. It is understandable that when a component is described as being “connected” or “coupled” to another component, it may be directly linked or coupled to another component, possibly involving intermediate components.

Referring to FIG. 2, it illustrates a block diagram of the electronic device according to an embodiment of the present disclosure. The electronic device 10 comprises a host device 110, a flash memory controller 130, and a flash memory device 150, and is suitable for integration into a wide range of electronic products, including but not limited to computers, smartphones, digital cameras/camcorders, wearable devices, and more. The flash memory controller 130 comprises a host interface 131, a processing unit 134, a read only memory (ROM) 135, a random access memory (RAM) 136, a register 137, and a flash memory interface 139. The bus 132 serves as a communication link connecting the host interface 131, the processing unit 134, the ROM 135, the RAM 136, the register 137, and the flash memory interface 139 for transmitting data, addresses, control signals, and more. The host device 110 communicates with the flash memory controller 130 through the host interface 131 according to the eMMC specification. The flash memory controller 130 communicates with the flash memory device 150 though the flash memory interface 139. The processing unit 134 is responsible for executing programs stored in the ROM 135, which involves receiving eMMC commands through the host interface 131 and executing these commands according to the present disclosure. The RAM 136 can serve as a buffer 138 and is utilized to store variables and other necessary data during execution. The register 137 is designated for storing various parameter values according to the eMMC specification.

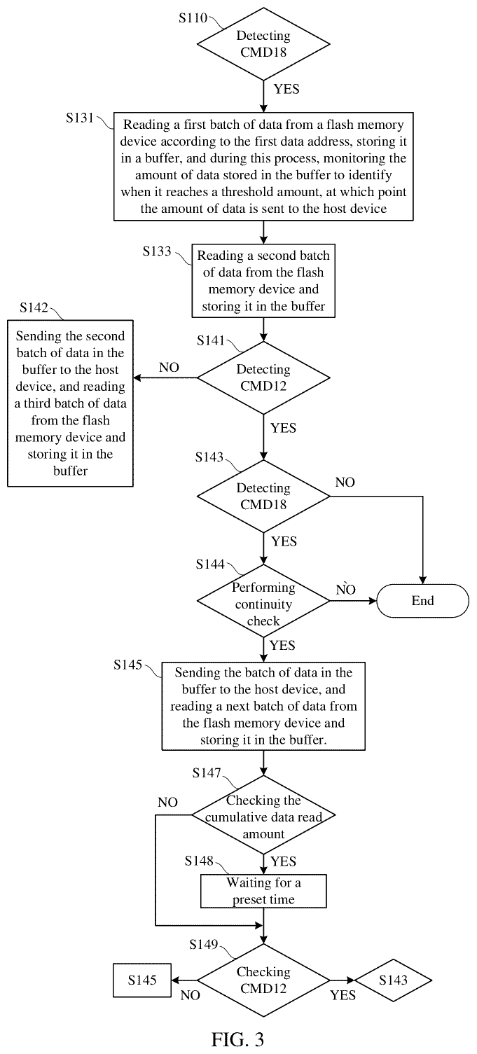

Referring to FIG. 3, it is a flowchart of the method for executing open-end read commands according to an embodiment of the present disclosure. The method is performed by the processing unit 134 of FIG. 2, and the execution steps are explained as follows. For ease of description, it is considered that an open-end read command has not yet been received. Step S110: When the processing unit 134 detects the reception of an open-end read command CMD18 from the host device 110, it proceeds to step S130; otherwise, the processing unit 134 performs other tasks (not shown in the figure).

Step S131: According to the data address specified in the open-ended read command CMD18 received, the first batch of data is read from the flash memory device 150 and stored in the buffer 138. During this process, when the amount of data stored in the buffer 138 reaches a threshold amount, that amount of data is then transmitted to the host device 110. After reading the first batch of data, proceed to step S133. Based on the eMMC specification and the number of memory chips and die per chip in the flash memory device, the amount of data read from the flash memory device 150 has a basic unit, such as 16 KB, 32 KB, or an amount corresponding to less than or equal to 64 LBAs (Logical Block Addresses). Subsequent explanations will use 32 KB as an example of the batch data-read amount. For ease of explanation, considering that the first batch of 32 KB data to be read from the flash memory device 150 is stored at consecutive addresses, thus step S131 needs only one DMA operation for reading. The mapping of the address specified in the open-ended read command CMD18 to the physical address in the flash memory device 150 can be referenced in the eMMC specification, which will not be elaborated here. The threshold amount is a value smaller than the batch-read data amount, herein the threshold amount is set to 4 KB as an example. While data is being stored in the buffer 138, this process monitors the amount of data stored in the buffer to identify when the amount of data reaches the threshold amount, at which point that amount of data is then sent to the host device 110. This allows the first batch of data to be sent to the host device 110 earlier, without needing to wait until all the first batch of data is stored in the buffer 138 before starting the transmission to the host device 110.

For the 32 KB data required to be read in flash memory device 150 which is spread out, step S131 will require more than one DMA operation. During the first DMA operation, the data stored in the buffer 138 will be monitored, and once it reaches the threshold amount, the data will be transferred to the host device 110. This ensures that the data in the buffer 138 can be sent to the host device 110 earlier.

Step S133: Read the second batch of data from the flash memory device 150 and store the second batch of data in the buffer 138. Following the end address of the first batch of data, the processing unit 134 uses DMA to read the next 32K data from the flash memory device 150 and stores it in the buffer 138.

Step S141: The processing unit 134 checks whether it has received the stop command CMD12. If the check result is YES, it proceeds to step S143; if the check result is NO, it proceeds to step S142. It is noteworthy that for case of reading a small amount of required data, the host device 110 will issue a stop command CMD12 after receiving the first batch of data. Therefore, in step S141, it should be detected that a stop command CMD12 has been received.

Step S142: Send the second batch of data in the buffer 138 to the host device 110 and read the third batch of data from the flash memory device 150, storing the third batch of data in the buffer 138. After step S142, it will go back to (not shown in the diagram) step S141 to detect if a stop command CMD12 has been received. If the result is NO, an action similar to step S142 will be executed: transferring the current batch of data in the buffer 138 to the host device 110 and reading a next batch of data from the flash memory device 150, storing it in the buffer 138.

Step S143: The processing unit 134 checks whether it has received an open-ended read command CMD18. If the check result is NO, the current process ends. If the check result is YES, it means that after receiving the stop command CMD12 (step S141), the processing unit then receives another open-ended read command CMD18. In this case, proceed to step S144.

Step S144: Perform continuity check, if the check result is YES, proceed to step S145; if the check result is NO, end the current process. The stop command CMD12 detected in step S141 indicates the end of the first open-ended read command CMD18. The accumulated amount of data transferred to the host device 110 is referred to as the cumulative data read amount of the first open-ended read command CMD18. If this cumulative data read amount is less than or equal to a default threshold, such as 32 KB, 16 KB, or an amount corresponding to less than or equal to 64 LBAs, such a case is defined as a small amount of required data. Another open-ended read command CMD18 is detected, indicating the start of a new open-ended read command CMD18. The continuity check comprises a check condition: (1) The data address of the current open-ended read command CMD18 follows immediately after the end address of the data read by the previous open-ended read command. In other words, the data block required by the current open-ended read command CMD18 immediately follows the data block read by the previous open-ended read command CMD18. The end address of the data read by the previous open-ended read operation can be calculated by the data address and cumulative data read amount of the previous open-ended read command CMD18. Since the cumulative data read amount of the previous open-ended read command CMD18 is often a small amount of required data, this continuity check condition may optionally further comprise another condition: (2) The cumulative data read amount of the previous open-ended read command CMD18 is a small amount of required data.

Step S145: When the batch of data in the buffer 138 is complete, the processing unit 134 sends the batch of data in the buffer 138 to the host device 110, reads the next batch of data from the flash memory device 150 and stores it in the buffer 138. Based on the condition (2) in step S144, it can be found that the second batch of data read in step S133 corresponding to the first open-ended read command CMD18 is just the first batch of data needed for the second open-ended read command CMD18, so this batch of data can thus be sent to the host device 110 via DMA. That is, this batch of data can be considered as the data read of the second open-ended read command CMD18. In addition to driving the DMA to transfer data to the host device 110, the processing unit 134 in this step also performs other processing (not shown in the figure). After a period of time, the processing unit 134 reads a next batch of data from the flash memory device 150 and storing it in the buffer 138.

Step S147: Check whether the cumulative data read amount of the current open-ended read command CMD18 is greater than or equal to the cumulative data read amount of the previous open-ended read command CMD18. If the check result is YES, it implies that the cumulative data read amount of the current new open-ended read command CMD18 might be nearing the cumulative data read amount of the previous open-ended read command CMD18, especially if the cumulative data read amount of the previous open-ended read command CMD18 is a small amount of required data, such a possibility will become higher. Therefore, after waiting for a preset time in step S148, before moving to step S149, there is an opportunity to detect the stop command CMD12 from the host device 110. In the case of a negative check result, proceed directly to step S149.

Step S149: The processing unit 134 checks whether a stop command CMD12 has been received from the host device 110. If the check result is YES, it means that the second open-ended read command CMD18 has ended. Subsequent processing steps (not shown in the diagram) include: returning to the execution of steps S143 to S149. If the check result is NO, it means that the second open-ended read command CMD18 has not yet ended. Subsequent processing steps (not shown in the diagram) include: returning to the execution of steps S145 to S149.

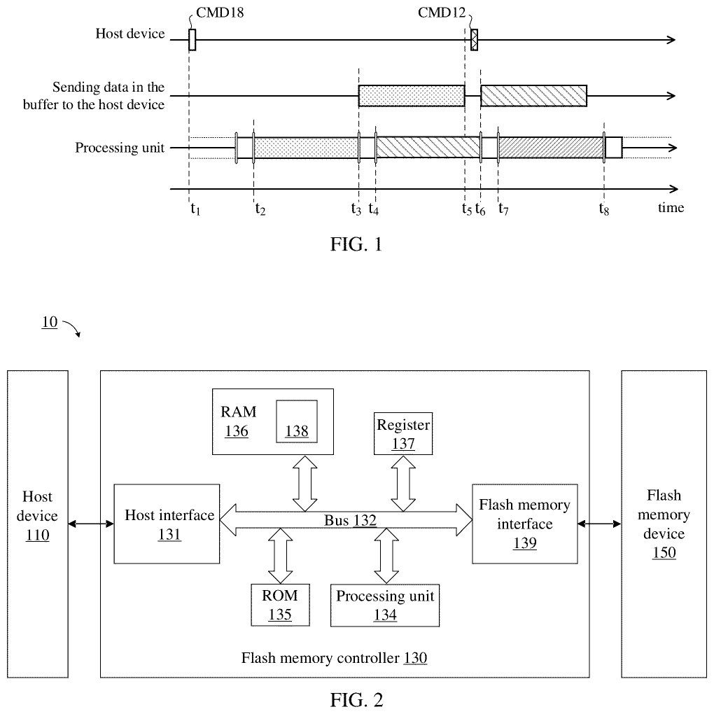

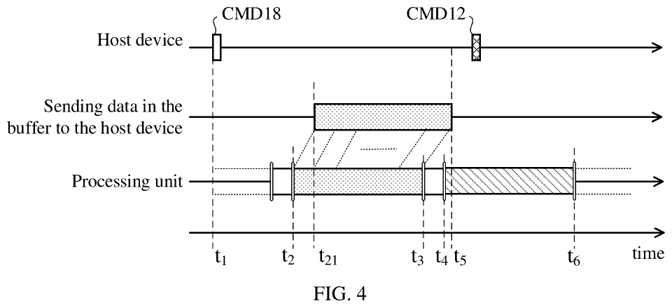

Referring to FIG. 4, it is a timing diagram illustrating the operation process of a single open-ended read command for reading a small amount of required data, corresponding to the embodiment shown in FIG. 3. At time t₁, the host device 110 sends an open-ended read command CMD18, considering that the previous read command sent was not CMD18. The processing unit 134 in the controller 130 detects this as an open-ended read command CMD18 (step S110) and performs the first read operation at time t₂ (step S131), reading the first batch of 32 KB data from the flash memory device 150 via DMA, and temporarily storing the first batch of 32 KB data in the buffer 138. For the purpose of description, considering that the amount of the batch read data is 32 KB, and the 32 KB data is contiguous in the flash memory device 150, after the processing unit 134 completes the DMA operation at time t₃, the buffer 138 will have stored the complete first batch of 32 KB data. During the DMA operation, the processing unit 134 also checks when the data stored in the buffer 138 reaches a predefined threshold amount, for example, 4 KB, and at time t₂₁, the data in the buffer 138 is transferred to the host device 110. After a period of time, at time t₅, the host device 110 receives the complete 32 KB data, and sends a stop command CMD12 since it considers that the required data amount has been met. At time t₃, after the data reading operation is completed, the processing unit 134 spends time processing some tasks, including checking the stop command CMD12 and the open-ended read command CMD18. Since the stop command CMD12 is not yet received, at time t₄, the processing unit 134 performs the second batch data reading operation (step S133), reading a second batch of 32 KB data from the flash memory device 150 and storing the second batch of 32 KB data in the buffer 138, and completes at time t₆. The stop command CMD12 sent by the host device 110 should arrive before time t₆, and therefore at that time, the processing unit 134 checks (step S141) if a stop command CMD12 was received, and the check result will be YES, thus ending the execution of the open-ended read command. For the case where the host device 110 uses an open-ended read command CMD18 to read only a single batch of data, i.e., a small amount of required data, according to the embodiment of the present disclosure, the time difference between the host device sending the open-ended read command CMD18 and the stop command CMD12 is significantly shorter compared to the prior art shown in FIG. 1. The time spent by the processing unit 134 is from t₂ to t₆, which is also shorter than the time needed in the prior art (t₂ to t₈), thus improving eMMC data read performance.

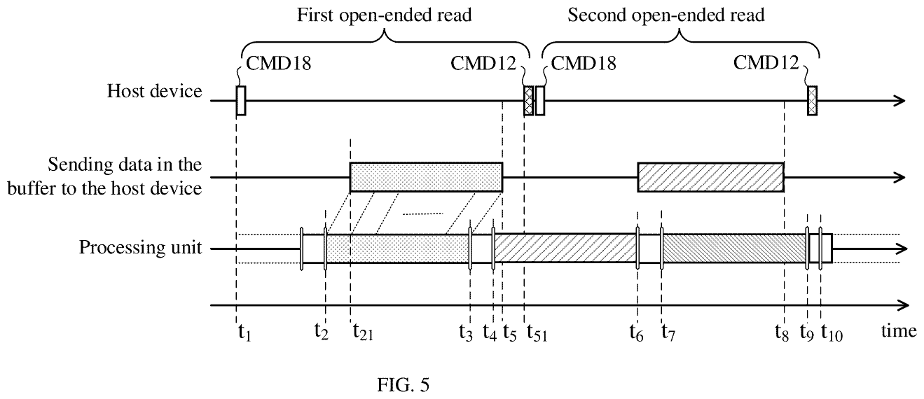

Referring to FIG. 5, the timing diagram illustrates the operation process of consecutive first and second open-ended read commands for reading a small amount of required data, corresponding to the embodiment shown in FIG. 3. The execution process of the first open-ended read command CMD18, which is the same as shown in FIG. 4 and will not be reiterated here. At time t₅, the host device 110 receives a batch of 32 KB data and determines that the required amount of data has been met, hence it issues a stop command CMD12. And suppose that the host device 110 requires additional data at the data address that is the data address of the first open-ended read command CMD18 plus 32 KB, the host device 110 will then issue a second open-ended read command CMD18. At time t₆, the processing unit 134 detects the stop command CMD12 (step S141) and the open-ended read command CMD18 (step S143) and performs a continuity check. If the check result is YES (step S144), then the data read in step S143 of the first open-ended read command CMD18 is exactly the data required for the second open-ended read command CMD18, which is then directly transmitted to the host device 110 (step S145), without affecting the processing unit 134 to perform other tasks. The processing unit 134 will perform other tasks and at a later time at t₇, the next batch of data reading is completed (step S145), retrieving 32 KB of data from the flash memory device 150 and temporarily storing it in the buffer 138. After some time, at time t₈, the host device 110 receives the batch of 32 KB data and issues a stop command CMD12 since it considers that the required data amount has been met. At time to after the data reading is completed, due to determining that the cumulative data read amount of the second open-ended read command CMD18 has reached the same as the cumulative data read amount of the first open-ended read command CMD18 (step S147), a preset time is waited for (step S148), and at time t₁₀ a check is performed to see if a stop command CMD12 has been received (step S149). The result of the check confirms the reception of the stop command CMD12, thereby ending the execution of the second open-ended read command. For the case that the host device 110 continuously issues open-ended read commands CMD18 for reading only a batch of data, i.e., a small amount of required data, the time difference between the host device issuing the second open-ended read command CMD18 and stop command CMD12 according to the embodiment of the present disclosure is significantly shorter than in the prior art depicted in FIG. 1. The time spent by the processing unit 134 is from t₆ to t₁₀, which is also shorter than the time required in the prior art of FIG. 1 from t₂ to t₈, thereby enhancing eMMC data read performance.

TABLE 1

| | | | Duration of an open-ended | |
|---|---|---|---|---|
| | | Required data | read command (ms) | |
| eMMC | | amount of the | | Embodiment of |
| command | Data address | host device | Prior art | the disclosure |
| CMD18 | 0x18c8c0 | 32 KB | 842 | 518 |
| CMD18 | 0x18c900 | 32 KB | 421 | 421 |
| CMD18 | 0x18c940 | 32 KB | 659 | 470 |
| CMD18 | 0x18c980 | 32 KB | 649 | 334 |
| CMD18 | 0x18c9c0 | 32 KB | 561 | 315 |

Please refer to Table 1, which illustrates the comparison of the duration of an open-ended read command between an embodiment of the present disclosure and the prior art. Here, the data address refers to the eMMC sector address, with a sector size of 512 bytes. The duration of an open-ended read command is measured in milliseconds (ms), indicating the time difference between the host device issuing the open-ended read command CMD18 and the corresponding stop command CMD12. For the case of small amount of required data, using the method and device for processing the open-ended read command as described in the present disclosure allows the flash memory controller to respond to the stop command from the host device more quickly compared to conventional method. This enables an earlier termination of the open-ended read operation, thereby enhancing read efficiency and avoiding unnecessary data transmission and delays in stopping transmission, ultimately reducing energy consumption and latency issues.

The aforementioned details represent only specific implementations of the present disclosure. However, the protection scope of the present disclosure is not limited thereto. Any modifications or replacements that can be easily devised by those skilled in the art within the technical scope of the present disclosure should all fall within the protection scope of the present disclosure. Consequently, the protection scope of the present disclosure should be defined by the protection scope of the appended claims.

What is claimed is:

1. A method of reading a flash memory card, executed by a processing unit of a flash memory controller, the method comprising:
(a) receiving a first open-ended read command from a host device, wherein parameters of the first open-ended read command include a first data address;
(b) reading a first batch of data from a flash memory device according to the first data address, storing the first batch of data in a buffer, and during this process, monitoring the amount of data stored in the buffer to identify when the amount of data reaches a threshold amount, at which point the amount of data is sent to the host device, wherein the threshold amount is less than a batch-read data amount;
(c) reading a second batch of data from the flash memory device and storing the second batch of data in the buffer; and
(d) checking if a stop command has been received from the host device, and if the check result is YES, terminating the execution of the first open-ended read command.

2. The method according to claim 1, wherein the batch-read data amount is 16 KB, 32 KB, or a data amount corresponding to less than or equal to 64 LBAs (Logical Block Addresses), and the threshold amount is 4 KB.

3. The method according to claim 1, wherein when the check result of step (d) is YES, the method further comprises:
(e) checking whether a second open-ended read command has been received, wherein parameters of the second open-ended read command include a second data address;
(f) performing a continuity check, and if the check result is YES, proceeding to step (g); and
(g) when a second batch of data in the buffer is complete, sending the second batch of data in the buffer to the host device, and reading a third batch of data from the flash memory device and storing the second batch of data in the buffer;
wherein the continuity check comprises a check condition: (1) the second data address follows immediately after an end address of the data read by the first open-ended read command.

4. The method according to claim 3, wherein the continuity check further comprises a check condition: (2) a cumulative data read amount of the first open-ended read command is a small amount of required data.

5. The method according to claim 4, wherein the small amount of required data refers to the cumulative data read amount of the first open-ended read command being 16 KB, 32 KB, or an amount of data associated with equal to or less than 64 LBAs.

6. The method according to claim 3, wherein, after step (g), the method further comprises:
(h) checking whether the cumulative data read amount of the second open-ended read command is greater than or equal to the cumulative data read amount of the first open-ended read command, and if the check result is YES, proceeding to step (i);
(i) waiting for a preset time; and
(j) checking if a stop command has been received from the host device.

7. An electronic device, comprising:
a host device;
a flash memory device; and
a flash memory controller, coupled to the host device and the flash memory device, wherein the flash memory controller comprises:
a host interface for coupling to the host device;
a flash memory interface for coupling to the flash memory device;
a buffer; and
a processing unit, coupled to the buffer, the host interface, and the flash memory interface, for receiving flash memory card commands from the host device through the host interface, and accessing the flash memory device through the flash memory interface, wherein the processing unit is configured to perform the following steps:
(a) receiving a first open-ended read command from the host, wherein parameters of the first open-ended read command include a first data address;
(b) reading a first batch of data from a flash memory device according to the first data address, storing the first batch of data in a buffer, and during this process, monitoring the amount of data stored in the buffer to identify when the amount of data reaches a threshold amount, at which point the amount of data is sent to the host device, wherein the threshold amount is less than a batch-read data amount;
(c) reading a second batch of data from the flash memory device and storing the second batch of data in the buffer; and
(d) checking if a stop command has been received from the host devices, and if the check result is YES, terminating the execution of the first open-ended read command.

8. The electronic device according to claim 7, wherein the batch-read data amount is 16 KB, 32 KB, or an amount corresponding to less than or equal to 64 LBAs (Logical Block Addresses) and the threshold amount is 4 KB.

9. The electronic device according to claim 7, wherein when the check result of step (d) is YES, the processing unit is configured to further perform the following steps:
(e) checking whether a second open-ended read command has been received, wherein the parameters of the second open-ended read command include a second data address;
(f) performing a continuity check, and if the check result is YES, proceeding to step (g); and
(g) when a second batch of data in the buffer is complete, sending the second batch of data in the buffer to the host device, and reading a third batch of data from the flash memory device and storing the third batch of data in the buffer;
wherein the continuity check comprises a check condition: (1) the second data address follows immediately after the end address of the data read by the first open-ended read command.

10. The device according to claim 9, wherein the continuity check further comprises a check condition: (2) a cumulative data read amount of the first open-ended read command is a small amount of required data.

11. The device according to claim 10, wherein the small amount of required data refers to the cumulative data read amount of the first open-ended read command being 16 KB, 32 KB, or an amount of data associated with equal to or less than 64 LBAs.

12. The device according to claim 9, wherein, after step (g), the processing unit is configured to further perform the following steps:
(h) checking whether the cumulative data read amount of the second open-ended read command is greater than or equal to the cumulative data read amount of the first open-ended read command, and if the check result is YES, proceeding to step (i);
(i) waiting for a preset time; and
(j) checking if a stop command has been received from one of the host devices.

13. A flash memory controller, coupled to a host device and a flash memory device, the flash memory controller comprising:
a host interface for coupling to the host device;
a flash memory interface for coupling to the flash memory device;
a buffer; and
a processing unit, coupled to the buffer, the host interface, and the flash memory interface, for receiving flash memory card commands from the host device through the host interface, and accessing the flash memory device through the flash memory interface, wherein the processing unit is configured to perform the following steps:
(a) receiving a first open-ended read command from the host, wherein parameters of the first open-ended read command include a first data address;
(b) reading a first batch of data from a flash memory device according to the first data address, storing the first batch of data in a buffer, and during this process, monitoring the amount of data stored in the buffer to identify when the amount of data reaches a threshold amount, at which point the amount of data is sent to the host device, wherein the threshold amount is less than a batch-read data amount;
(c) reading a second batch of data from the flash memory device and storing the second batch of data in the buffer; and
(d) checking if a stop command has been received from the host devices, and if the check result is YES, terminating the execution of the first open-ended read command.

14. The flash memory controller according to claim 13, wherein the batch-read data amount is 16 KB, 32 KB, or an amount corresponding to less than or equal to 64 LBAs (Logical Block Addresses), and the threshold amount is 4 KB.

15. The flash memory controller according to claim 13, wherein when the check result of step (d) is YES, the processing unit is configured to further perform the following steps:
(e) checking whether a second open-ended read command has been received, wherein the parameters of the second open-ended read command include a second data address;
(f) performing a continuity check, and if the check result is YES, proceeding to step (g); and
(g) when a second batch of data in the buffer is complete, sending the second batch of data in the buffer to the host device, and reading a third batch of data from the flash memory device and storing the third batch of data in the buffer;
wherein the continuity check comprises a check condition: (1) the second data address follows immediately after the end address of the data read by the first open-ended read command.

16. The flash memory controller according to claim 15, wherein the continuity check further comprises a check condition: (2) a cumulative data read amount of the first open-ended read command is a small amount of required data.

17. The flash memory controller according to claim 16, wherein the small amount of required data refers to the cumulative data read amount of the first open-ended read command being 16 KB, 32 KB, or an amount of data associated with equal to or less than 64 LBAs.

18. The flash memory controller according to claim 15, after step (g), the processing unit is configured to further perform the following steps:
(h) determining whether the cumulative data read amount of the second open-ended read command is greater than or equal to the cumulative data read amount of the first open-ended read command, and if the check result is YES, proceeding to step (i);
(i) waiting for a preset time; and
(j) checking if a stop command has been received from one of the host devices.
